(19) United States
(12) Patent Application Publication
(10) Pub. No.: US 2008/0028214 A1
(43) Pub. Date: Jan. 31, 2008

(54) Secure flash media for medical records

(76) Inventors: Ronald Tafoya, Sandia Park, NM (US); Jim S. Baca, Corrales, NM (US); Thomas Trodden, Albuquerque, NM (US); Esther I. Ferguson, Albuquerque, NM (US)

Correspondence Address: DARBY & DARBY P.C., P.O. BOX 770, Church Street Station, New York, NY, 10008-0770, US

(21) Appl. No.: 11/494,694

(22) Filed: Jul. 28, 2006

(51) Int. Cl. H04L 9/00

(52) U.S. Cl. 713/166

(57) ABSTRACT

The invention relates to a secure mobile device for storing data in a secure manner. The secure mobile device has a microarchitecture connected via an interface to flash memory on the device. The microarchitecture is able to authenticate the access of information stored on the secure mobile device using a private key. Upon authentication of the access of information, a record owner of the device may proved the stored information to third party trusted entities using an associated public key. The secure mobile device allows for secure transaction of confidential data on a variety of systems at a number of locations.

### FIELD OF THE INVENTION

The invention relates to the use of a secure flash media, in which the secure flash media includes a flash memory interfaced with an embedded security system.

### BACKGROUND

Recent national disasters in the United States, such as hurricanes Wilma and Katrina, have highlighted the risk run by only having medical records in hard copy form. During the flooding which occurred during these disasters, many patients lost all of their medical records. This also included loss of the “treatment cocktails” used as part of the treatment regimes for cancer patients and HIV positive patients. In a situation already compounded by lack of medical facilities, medical first responders were challenged in their triage and treatment of the victims of the disasters because medical records were destroyed. Many times they had to proceed without understanding the preexisting conditions and current treatment regimes of the victims prior to administering their emergency treatments.

In some situations, the victims, who later became patients, were able to give much more of the pertinent medical information to the responders. In other instances, however, the patient was unable to recall their medical history or simply unconscious and without any relative or friend available to provide this information. Finally, the disasters also highlighted the loss of other critical data for many of the disaster refugees. Some of these records included school records, wills, power of attorney forms, etc. which were also lost by the victims of the natural disasters.

While the medical community for a long time has been cognizant that electronic medical records can help avoid the catastrophic loss of medical records, there have been several obstacles to implementation of uniform medical records across the medical industry. One of the most challenging obstacles has been the lack of a security mechanism to control the access of the sensitive data in these records. This is compounded by the Health Insurance Portability and Accountability Act of 1996 (HIPAA), which has imposed significant regulatory requirements on the security and privacy of health data.

Many of the records and data discussed above are often confidential and require a degree of security to prevent misuse of the information. Currently, security measures use algorithms and keys to accomplish protection.

### BRIEF DESCRIPTION OF THE DRAWINGS

FIG. 1 illustrates a restricted security system known in the prior art.

FIG. 2 illustrates a security system using encryption and decryption keys, as known in the prior art.

FIG. 2A illustrates a security system using encryption and decryption keys, in which the keys are different, as known in the prior art.

FIG. 3 illustrates communication between authorized users.

FIG. 4 illustrates one embodiment of the invention.

FIG. 5 illustrates another embodiment of the invention.

FIG. 6 illustrates the FACET microarchitecture.

FIG. 7 illustrates an authenticated write scenario with authentication protocol including synchronization with a trusted entity.

FIG. 8 illustrates an exemplary use of the data by a record owner.

FIG. 9 illustrates an exemplary use of the invention.

### DETAILED DESCRIPTION

In one embodiment of the invention, there is a device, comprising a memory to store data; a private key; a microcontroller to authenticate the private key to access the data from memory; and a data line interface to connect the microcontroller and memory, such that the data stored on the memory is securely communicated to the microcontroller upon authentication.

In an aspect of the invention, the device is at least one of a recording media and flash media. In another aspect, the memory is a flash memory embedded on the portable media device. In yet another aspect of the invention, the flash memory is divided into at least two separate storage areas, each accessible at a different level of security. In still another aspect, the at least two separate storage areas are accessed by an external source using a public key corresponding to the appropriate level of security. Also, in an aspect of the invention, the microcontroller includes security circuitry which authenticates the data stored in the memory using the private key. In another aspect of the invention, after authentication of the data stored in the memory, the data is accessible by an external source having a corresponding public key. In yet another aspect, the external source is a central repository to store and archive the data stored in the memory.

In another embodiment, there is a method of securing data within a device, comprises storing data on a memory of the device; providing a private key; authenticating the private key using a microcontroller located on the device to access the data from memory; and connecting the microcontroller and the memory using a data line interface, such that the data stored on the memory is securely communicated to the microcontroller upon authentication.

In another aspect, the device is at least one of a recording media and flash media. In another aspect, the device is at least one of a recording media and flash media. In still another aspect, the memory is a flash memory embedded on the portable media device. In still another aspect, the flash memory is divided into at least two separate storage areas, each accessible at a different level of security. In yet another aspect, the at least two separate storage areas are accessed by an external source using a public key corresponding to the appropriate level of security. In another aspect, the microcontroller includes security circuitry which authenticates the data stored in the memory using the private key. In another aspect of the invention, after authentication of the data stored in the memory, the data is accessible by an external source having a corresponding public key. In still another aspect, the external source is a central repository to store and archive the data stored in the memory.

In yet another embodiment of the invention, there is a secure system for transfer of data has a microcontroller to authenticate a private key and access the data from memory; a central repository to store and archive the data located on the device; and an interface to connect the device with the central repository, wherein upon authentication of the central repository the secure data may be transferred therebetween. The device is a flash memory and the private key is located in the device.

In another aspect of the secure system for transfer of data, the central repository uses a public key corresponding to the private key in order to obtain authentication. In yet another aspect of the secure system for transfer of data, the device is at least one of a recording media and flash media, and the flash memory is divided into at least two separate storage areas, each accessible at a different level of security.

In still another aspect, wherein the at least two separate storage areas are accessed by an external source using a public key corresponding to the appropriate level of security. In another aspect, the microcontroller includes security circuitry which authenticates the data stored in the device using the private key.

In an aspect of the invention, there is a method of securing data transfer over a system, comprising authenticating a private key on a device using a microcontroller to access the data store on the device; storing and archiving the data located on the device in a central repository; and connecting the device with the central repository through an interface, wherein upon authentication of the central repository the secure data may be transferred therebetween.

In another aspect, the device is a flash memory and the private key is located in the device, wherein the central repository uses a public key corresponding to the private key in order to obtain authentication. In still another aspect of securing data transfer, the central repository uses a public key corresponding to the private key in order to obtain authentication. In yet another aspect, the device is at least one of a recording media and flash media wherein the flash memory is divided into at least two separate storage areas, each accessible at a different level of security. In another aspect, the at least two separate storage areas are accessed by an external source using a public key corresponding to the appropriate level of security. In still another aspect, the microcontroller includes security circuitry which authenticates the data stored in the device using the private key.

This invention provides a secure portable media, such as a flash media, to control access of data stored on the media. The secure portable media may be used in connection with an overall system in order to provide data to various entities in a secure manner. In one embodiment, the system includes a flash media designed to directly interface with a personal computer or other storage device. The interfacing of the flash media with the personal computer will be used, for example, in conjunction with a certificate system authentication, which will have components on both the client and host sides. The combination of the flash media and system authentication creates a secure flash media system ideal for storing confidential information. There are several techniques that may be used to secure this information.

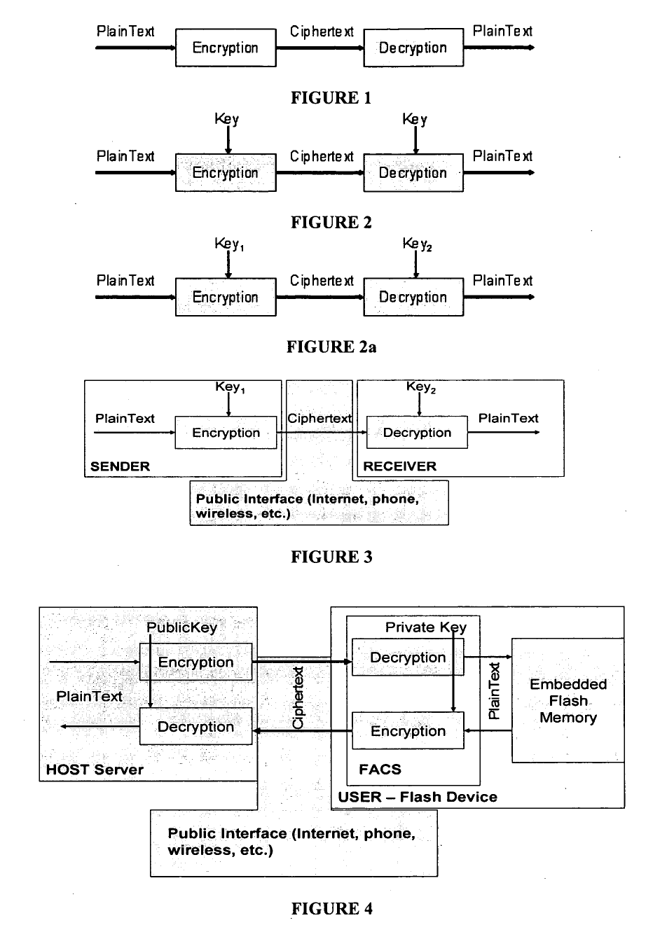

A cryptographic algorithm may be used, which typically is a mathematical function used to encrypt and decrypt data. Both of theses functions are generally employed in an overall system, such as the one briefly described above, to secure data. If the security of the cryptography is based on keeping the algorithm secret, then the algorithm is defined as restricted. This is illustrated in FIG. 1. There are many problems with using a system based on a restricted algorithm, such as no quality control or standardization of the algorithm. Additionally, changes in a large group of users require frequent changing of the algorithm to maintain security of the system. Despite its short comings, restricted algorithms are very popular in low security applications.

Cryptography solves the problems of restricted systems by implementing a key. Both the encryption and decryption operations use a key and are dependant on them, as illustrated in FIG. 2. Some algorithms use a different encryption key and decryption key, as illustrated in FIG. 2a.

The security in the algorithms illustrated in FIGS. 2 and 2a are based on the security of the key (or keys). None of the security is based in the details of the mathematical encryption or decryption algorithms. This allows these algorithms to be published and standardized, thus overcoming many of the limitations of restricted algorithms.

Another type of security uses keyed algorithms. There are two general types of key-based algorithms: symmetric and public key. Symmetric algorithms, sometimes called conventional algorithms, are algorithms where the encryption key can be calculated from the decryption key and vice versa. In most symmetric algorithms, the encryption key and decryption key are the same, like that shown in FIG. 2. Public-key algorithms, sometimes called asymmetric algorithms, on the other hand, are designed so that the key for encryption is different from the key used for decryption. This was illustrated above in FIG. 2a. Additionally, the decryption key cannot be calculated from the encryption key. These algorithms are called public-key because the encryption key can be made public. Someone can use the encryption key to encrypt a message, but only a specific person with the corresponding decryption key can decrypt the message. In these systems, the encryption key is often the public key and the decryption key is often the private key.

Cryptography seeks to keep the plaintext (or the key, or both) secret from eavesdroppers. Eavesdroppers are assumed to have complete access to the communications between the sender and receiver, as illustrated in FIG. 3.

In public-key cryptography, the host keeps a file of every user's public key, and all users keep their own private keys. With reference to FIG. 3, the following is an exemplary protocol model for authentication.

1. The HOST sends the user a random string.

2. The USER encrypts the string with their private key and sends it back to the HOST, along with their USER ID.

3. The HOST looks up the USER's public key in its database and decrypts the message using that public key.

4. If the decrypted string matches what the HOST originally sent the USER, the HOST allows the USER access to the system.

Since no one else has access the user's private key, no one else can impersonate the user. More importantly, the user never sends their private key over the transmission line to the host. Thus, a hacker, listening in on the interaction, cannot obtain any information that would enable them to deduce the private key and impersonate the user.

Secure proof-of-identity protocols take on a more complicated form, as detailed in the example scenario below.

1. The USER performs a computation based on some random numbers and their private key and sends the result to the HOST.

2. The HOST sends the user a different random number.

3. The USER makes some computation based on the random numbers (both the ones they generated and the one they received from the HOST) and their private key, and sends the result to the HOST.

4. The HOST does some computation on the various numbers received from the USER and their public key to verify that the USER knows their private key.

5. If the USER knows their private key, then their identity is verified.

FIG. 4 illustrates a high level embodiment of the system of the invention using known authentication and cryptography techniques, as detailed above. In this example, the secure system includes a host server and a flash device, connected via a public interface, such as the Internet. The flash device includes an embedded flash memory and a microcontroller which are connected via an embedded interface. A product such as a microcontroller with an embedded flash memory could also be used. The interface embedded between the microcontroller and the flash memory prevents direct access to information (i.e. unencrypted/non-secure data) flowing between the memory and the microcontroller. In order to access the data, it must first be authenticated and/or decrypted using a private key. Use of the private key to decrypt the plaintext information provides a uniquely secure means for storing data on a portable media. Once the information stored in memory has been authenticated and accessed, it may be sent to an external location, such as the host server depicted in the diagram. In order for the host server to access the data, a public key will be required to authenticate use of the data. It should be noted that a flash device is used in this example, although the system could also be equally applied to a wide variety of products, including cell phones, satellite receivers, PDAs, USB devices, etc.

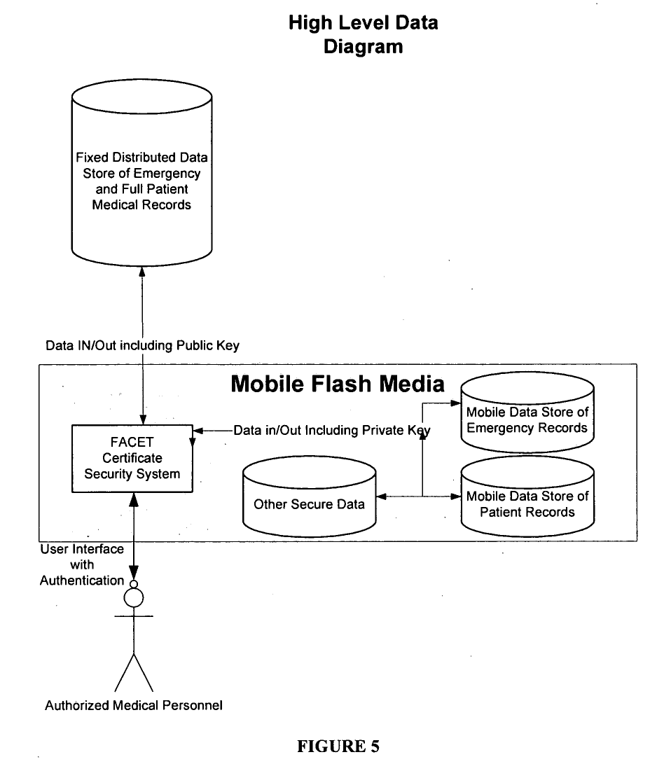

FIG. 5 illustrates a more specific example of the system illustrated in FIG. 4. The system depicted in this figure includes a mobile flash media, a fixed distributed data store and an authorized medical personnel. The mobile flash media includes three distinct storage areas—mobile data store of emergency records, mobile data store of patient records and other secure data. The mobile flash media also includes the FACET certificate security system, which interfaces with the data stored on the mobile flash media, and with external sources. Data exchanged between the storage areas and the security system thus requires a private key. This embedded exchange of data is important, since it ensures secure communication of data on the flash media device, without exposure to external sources. In order for the authorized medical person to gain access to the information stored on the flash media, a corresponding public key must be provided. Once a public key is obtained, the system can provide data to the authenticated person or entity. Data may be provided in different levels of access dependant upon the role of the person or entity requesting access, and the security privileges required for the data. The various levels may include, for example, level one access for emergency medical records only, level two for access of full medical records, level three for access of non-medical records only, and level four for access of all data. The data is then displayed based upon the security level authorized.

Furthermore, additional data redundancy may be provided in the form of archived backups or a central repository. This reduces the risk of data loss, and enables logging records which allows for a history of access and changes to be kept. The system can also have a central, secure records database repository which duplicates all records on the mobile media, and allow for secure remote update of the central repository on a regular basis, either from the trusted entity (such as a provider medical system) or from the user (or patient) home system. The central repository data can therefore be used to re-create the entire set of data for a replacement media should the user lose the original media. Data access to and from the central repository may also be logged and that information will be retained to record the data history.

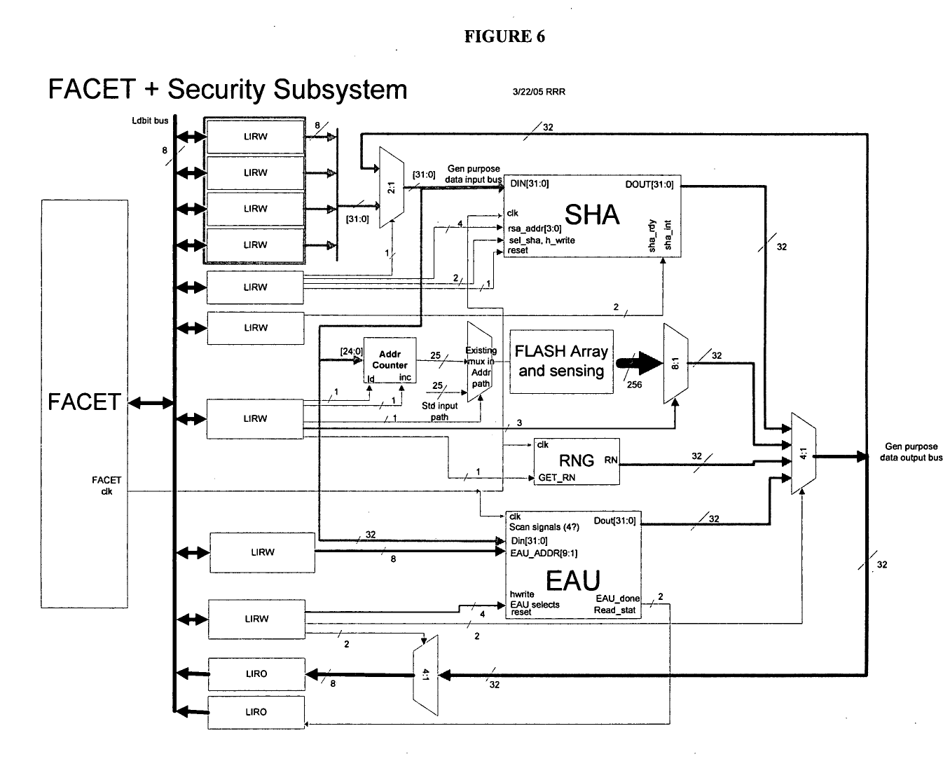

FIG. 6 illustrates the a micro architecture capable of supporting authenticated operations feature set (the Pennsbury architecture) which can include public key management, random number generator, authenticated program/erase via differencing file, flash read protection, and customer-configurable flash regions that can only be modified by signed packages. The presented micro architecture utilizes the onboard Flash Algorithm Control Engine II (FACET) microcontroller and adds an additional security sub-system. The security sub-system is composed of components that include; Read/Write interface registers (LIRW), Read Only interface registers (LIRO), a random number generator (RNG), an industry standard hash algorithm used in several public security protocols, Secure Hash Algorithm Engine (SHA), a public-private key cryptography engine (RSA—named for the three who invented it; Rivest, Shamir, Adelman) and a Execution Arithmetic Unit (EAU) used to perform mathematic operations with in the security sub-system.

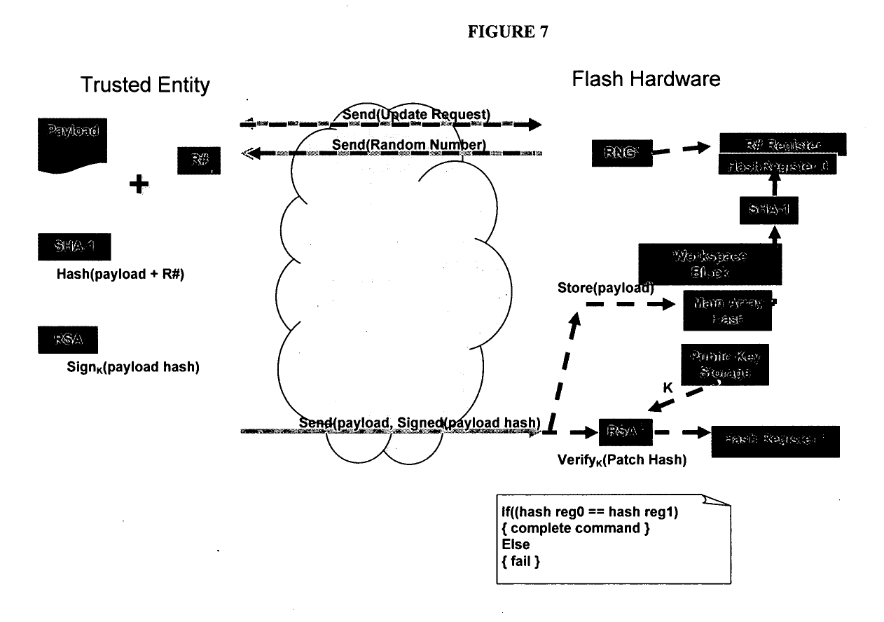

FIG. 7 illustrates an exemplary system flow of secure data between a flash device (FLASH HARDWARE) and a TRUSTED ENTITY (e.g. a health service provider) through a public interface (for example, the Internet). The intent of this process is to first establish the requestor as a trusted entity prior to allowing access to the secure data

The first action is a request by the REQUESTOR to perform a secured operation, in this case, a secured write. The FLASH HARDWARE responds by providing the REQUESTOR with a random number. Additionally, the FLASH HARDWARE keeps a copy of this random number for future use in a register identified as R# REGISTER.

The REQUESTOR receives the random number generated by the FLASH HARDWARE and combines it algorithmically with the payload it wants to deliver using the SHA Engine. The resulting HASH (payload+random number) is then signed using public-private key cryptography by the RSA engine. Once completed, the REQUESTOR then sends original payload and SIGNED HASH payload to the FLASH HARDWARE.

Upon receipt, the FLASH HARDWARE verifies the REQUESTOR's signature by using a RSA engine (public-private key cryptography) and the public key. This is to determine if the TRUSTED is trusted. If the TRUSTED fails the test, it is not trusted and the data is discarded. If it passes the test, the REQUESTOR is now TRUSTED the resulting HASH (payload+random number) is stored in HASH REGISTER 1.

The next step is to determine that the data sent is original. Using its own SHA, the FLASH HARDWARE combines the original payload with the random number it generated (stored R# REGISTER) and stores the result in HASH REGISTER 0. The FLASH HARDWARE then compares the contents of HASH REGISTER 0 with HASH REGISTER 1. If they match, then the data is determined to be valid and the write operation is performed. If they don not match, the data is determined to be corrupted and is discard without performing the requested write operation.

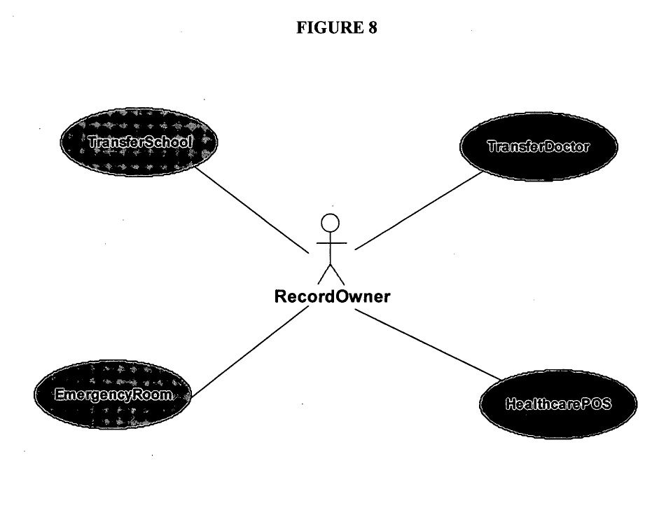

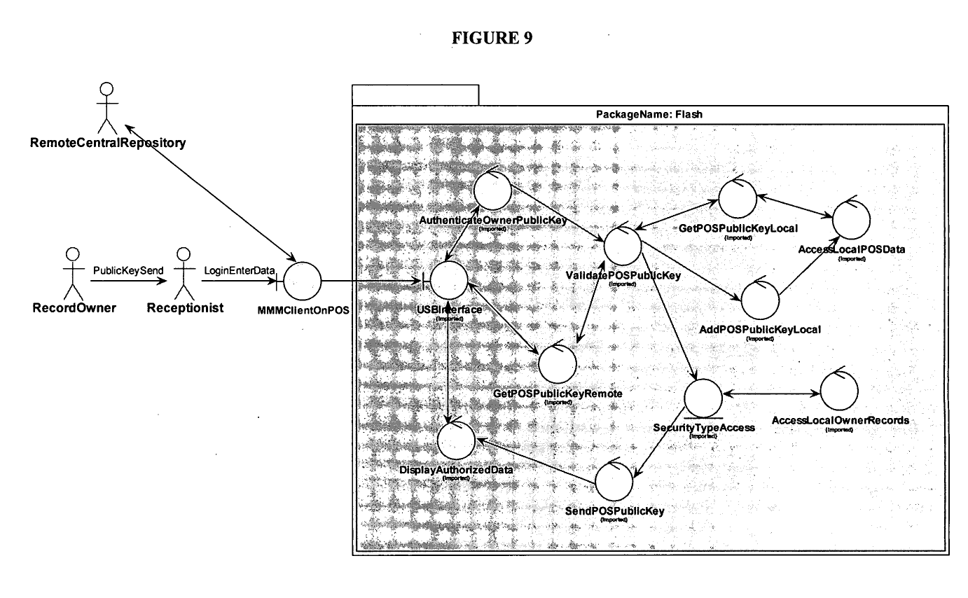

The following is an exemplary use case scenario, which is explained below with reference to FIGS. 8 and 9. As depicted in FIG. 8, the user (i.e. record owner) of the data, can use the mobile flash media device with numerous trusted entities. For example, the record owner can transfer data securely between a school, doctor, hospital (i.e. emergency room) and/or a healthcare provider (i.e. healthcare POS). The various trusted entities may even have different levels of security. For example, the emergency room may have full access to all data on the device due to the urgent nature of the care, whereas the healthcare POS may only have rights to the data related to billing and address. Regardless of the level of security, the record owner is free to use the mobile flash device at a variety of different locations, without concern as to forfeiting confidential data.

Referring to FIG. 9, a record owner (patient) seeks healthcare services with a new healthcare provider. The patient (and owner of the healthcare medical record seeking healthcare services) receives medical attention from the new healthcare provider, and in doing so desires to provide the medical records to a new service provider. By changing providers, the patient will encounter a variety of individuals that will require access to various levels of the medical records. For example, the patient will encounter (1) an attending physician—to view all relevant patient medical records that are required and provide healthcare services; (2) healthcare service receptionist—the person at the front desk of the healthcare provider that ensures all patients who see the attending physician have medical records available to the physician and that the patient has insurance coverage; and (3) the healthcare business manager—to make sure that all guidelines for HIPAA privacy and patient information are followed.

When the patient arrives at the new healthcare facility, she is greeted by the healthcare receptionist. The receptionist requests the medical records stored on the mobile device, which the patient provides, and asks for the patient's public key which exists, for example, on his insurance card. The patient provides the corresponding public key, and the receptionist plugs the mobile device into her new patient receiving computer system. The system prompts the receptionist for the public key (I).

The receptionist enters the patient public key and the healthcare provider public key and the attending physician's doctor number, and the computer system validates the patient public key against the mobile device private key for security system access (II). When the patient public key is authenticated, the system performs a similar authentication against the healthcare provider public key (III). Since this is a new healthcare provider, the healthcare provider public key is not found in the currently valid and active healthcare providers list resident in the memory of the mobile device.

The mobile device security system approves access to the public key infrastructure system for doctor validation against the mobile device central repository doctor database (IV). The central repository then validates the doctor number, and provides a valid entity public key access signal to the mobile device (V). Level 4 access (access to insurance provider information) on the mobile device is provided to the receptionist and level 2 access (full medical record access) to the attending physician through the client mobile medical record application residing on the healthcare provider computer system (VI). The healthcare provider public key is added to the valid and active list of providers on the mobile device.

The receptionist subsequently reviews the insurance information resident on the flash media, and displayed on the healthcare provider receptionist screen, that is provided by the mobile record client application on the healthcare provider computer system and transfers the appropriate information to her billing system.

The client application on the healthcare provider system makes the medical record of the patient available to the attending physician using appropriate login and access security measures (VII). The attending physician reviews the reason for today's patient visit and mobile medical records while the patient is waiting to see the attending physician.

The patient sees the attending physician and is diagnosed in the normal manner. The attending physician makes the appropriate entries to the healthcare provider's billing system and returns to the front desk for normal final interaction with the receptionist (e.g., schedule a follow up appointment and co-pay insurance payment).

The receptionist uses the healthcare receptionist screen that is provided by the mobile record client application on the healthcare provider computer system to enter the billing, vitals, ICDA, HICFA information and any physician notes on the mobile device, which remains plugged into the computer system (VIII). The mobile medical record security system records the entries on the mobile device, and sends a data update to the mobile medical record central repository.

This invention is not limited to the above disclosed embodiments. The skilled artisan will readily understand that this invention may be applied to a variety of applications, including but limited to those above.

1. A device, comprising:
a memory to store data;
a private key;
a microcontroller to authenticate the private key to access the data from memory; and
a data line interface to connect the microcontroller and memory, such that the data stored on the memory is securely communicated to the microcontroller upon authentication.

2. The device of claim 1, wherein the device is at least one of a recording media and flash media.

3. The device of claim 1, wherein the memory is a flash memory embedded on the portable media device.

4. The device of claim 3, wherein the flash memory is divided into at least two separate storage areas, each accessible at a different level of security.

5. The device of claim 3, wherein the at least two separate storage areas are accessed by an external source using a public key corresponding to the appropriate level of security.

6. The device of claim 1, wherein the microcontroller includes security circuitry which authenticates the data stored in the memory using the private key.

7. The device of claim 6, wherein after authentication of the data stored in the memory, the data is accessible by an external source having a corresponding public key.

8. The device of claim 7, wherein the external source is a central repository to store and archive the data stored in the memory.

9. A method of securing data within a device, comprising:
storing data on a memory of the device;
providing a private key;
authenticating the private key using a microcontroller located on the device to access the data from memory; and
connecting the microcontroller and the memory using a data line interface, such that the data stored on the memory is securely communicated to the microcontroller upon authentication.

10. The method of securing data of claim 9, wherein the device is at least one of a recording media and flash media.

11. The method of securing data of claim 9, wherein the memory is a flash memory embedded on the portable media device.

12. The method of securing data of claim 11, wherein the flash memory is divided into at least two separate storage areas, each accessible at a different level of security.

13. The method of securing data of claim 1 1, wherein the at least two separate storage areas are accessed by an external source using a public key corresponding to the appropriate level of security.

14. The method of securing data of claim 9, wherein the microcontroller includes security circuitry which authenticates the data stored in the memory using the private key.

15. The method of securing data of claim 14, wherein after authentication of the data stored in the memory, the data is accessible by an external source having a corresponding public key.

16. The method of securing data of claim 15, wherein the external source is a central repository to store and archive the data stored in the memory.

17. A secure system for transfer of data; comprising:
a device having a microcontroller to authenticate a private key and access the data from memory;
a central repository to store and archive the data located on the device; and
an interface to connect the device with the central repository, wherein upon authentication of the central repository the secure data may be transferred therebetween.

18. The secure system for transfer of data of claim 17, wherein the device is a flash memory.

19. The secure system for transfer of data of claim 17, wherein the private key is located in the device.

20. The secure system for transfer of data of claim 17, wherein the central repository uses a public key corresponding to the private key in order to obtain authentication.

21. The secure system for transfer of data of claim 17, wherein the device is at least one of a recording media and flash media.

22. The device of claim 18, wherein the flash memory is divided into at least two separate storage areas, each accessible at a different level of security.

23. The device of claim 22, wherein the at least two separate storage areas are accessed by an external source using a public key corresponding to the appropriate level of security.

24. The device of claim 17, wherein the microcontroller includes security circuitry which authenticates the data stored in the device using the private key.

25. A method of securing data transfer over a system, comprising:
authenticating a private key on a device using a microcontroller to access the data store on the device;
storing and archiving the data located on the device in a central repository; and
connecting the device with the central repository through an interface, wherein upon authentication of the central repository the secure data may be transferred therebetween.

26. The method of securing data transfer of claim 25, wherein the device is a flash memory.

27. The method of securing data transfer of claim 25, wherein the private key is located in the device.

28. The method of securing data transfer of claim 25, wherein the central repository uses a public key corresponding to the private key in order to obtain authentication.

29. The method of securing data transfer of claim 25, wherein the device is at least one of a recording media and flash media.

30. The method of securing data transfer of claim 26, wherein the flash memory is divided into at least two separate storage areas, each accessible at a different level of security.

31. The method of securing data transfer of claim 30, wherein the at least two separate storage areas are accessed by an external source using a public key corresponding to the appropriate level of security.

32. The method of securing data transfer of claim 25, wherein the microcontroller includes security circuitry which authenticates the data stored in the device using the private key.
